(19) United States
(12) Patent Application Publication
(10) Pub. No.: US 2026/0153709 A1
(43) Pub. Date: Jun. 4, 2026

(54) IMAGING OPTICAL SYSTEM AND IMAGING DEVICE

(71) Applicant: NIDEC INSTRUMENTS CORPORATION, Nagano (JP)

(72) Inventor: Tadashi KOMIYAMA, Nagano (JP)

(73) Assignee: NIDEC INSTRUMENTS CORPORATION, Nagano (JP)

(21) Appl. No.: 19/399,637

(22) Filed: Nov. 25, 2025

(30) Foreign Application Priority Data
Nov. 29, 2024 (JP) 2024-208185

(51) Int. Cl. G02B 13/00; G02B 9/62

(52) U.S. Cl. CPC G02B 13/0045; G02B 9/62

(57) ABSTRACT

An imaging optical system includes, in order from an object side toward an image side, a front group, a diaphragm, and a rear group. The front group is constituted of, in order from the object side toward the image side, a first lens and a second lens. The rear group is constituted of, in order from the object side toward the image side, a third lens, a fourth lens, a fifth lens, and a sixth lens. When it is assumed that a viewing angle in a horizontal direction is HFOV, the entire length between the lenses of the front group is df, and the entire length between the lenses of the rear group is dr, the imaging optical system satisfies the following conditional expressions:

$$100 < HFOV \qquad ( 1 )$$

$$df / dr < 0.600 \qquad ( 2 )$$

### CROSS REFERENCE TO RELATED APPLICATION

The present application claims priority under 35 U.S.C. § 119 to Japanese Application No. 2024-208185 filed Nov. 29, 2024, the entire content of which is incorporated herein by reference.

### TECHNICAL FIELD

At least an embodiment of the disclosure relates to an imaging optical system and an imaging device.

### DESCRIPTION OF THE RELATED DOCUMENTS

An imaging optical system for use in an in-vehicle camera or a monitoring camera is described in Japanese Unexamined Patent Application Publication No. 2022-181228. The imaging optical system in Japanese Unexamined Patent Application Publication No. 2022-181228 is constituted of an aperture diaphragm, a first lens group disposed on an object side with respect to the aperture diaphragm, and a second lens group disposed on an image side with respect to the aperture diaphragm. The first lens group is constituted of two lenses. The second lens group is constituted of four lenses. Among the lenses of the first lens group, a first lens disposed closest to the object side is exposed from a lens barrel or the like that covers the imaging optical system.

In an imaging optical system for use in an in-vehicle camera or a monitoring camera, it is required to reduce the size of a first lens from the viewpoint of design and from the viewpoint of suppressing a user from feeling that the user is being monitored. However, in the imaging optical system in Japanese Unexamined Patent Application Publication No. 2022-181228, it is difficult to reduce the size of the first lens, while suppressing lowering in optical characteristics.

At least an embodiment of the disclosure provides an imaging optical system capable of reducing the size of a first lens, while suppressing lowering in optical characteristics, and an imaging device including the imaging optical system.

### SUMMARY

An aspect of an imaging optical system of at least an embodiment of the disclosure includes, in order from an object side toward an image side, a front group, a diaphragm, and a rear group. The front group is constituted of, in order from the object side toward the image side, a first lens and a second lens. The rear group is constituted of, in order from the object side toward the image side, a third lens, a fourth lens, a fifth lens, and a sixth lens. When it is assumed that a viewing angle in a horizontal direction is HFOV, the entire length between the lenses of the front group is df, and the entire length between the lenses of the rear group is dr, the imaging optical system satisfies the following conditional expressions:

$$100 < HFOV \qquad ( 1 )$$

$$df / dr < 0.58 \qquad ( 2 )$$

An aspect of an imaging device of at least an embodiment of the disclosure includes an imaging optical system, and an imaging element disposed on an image side of the imaging optical system.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is an explanatory diagram of an imaging device according to a first embodiment;

FIG. 2 is a diagram illustrating data of an imaging optical system according to the first embodiment;

FIG. 3 is a diagram illustrating spherical aberrations of the imaging optical system illustrated in FIG. 1;

FIG. 4 is a diagram illustrating chromatic aberrations of magnification of the imaging optical system illustrated in FIG. 1;

FIG. 5 is a diagram illustrating astigmatisms and distortions of the imaging optical system illustrated in FIG. 1;

FIG. 6 is a diagram illustrating lateral aberrations of the imaging optical system illustrated in FIG. 1;

FIG. 7 is an explanatory diagram of an imaging device according to a second embodiment;

FIG. 8 is a diagram illustrating data of an imaging optical system of the second embodiment;

FIG. 9 is a diagram illustrating spherical aberrations of the imaging optical system illustrated in FIG. 7;

FIG. 10 is a diagram illustrating chromatic aberrations of magnification of the imaging optical system illustrated in FIG. 7;

FIG. 11 is a diagram illustrating astigmatisms and distortions of the imaging optical system illustrated in FIG. 7;

FIG. 12 is a diagram illustrating lateral aberrations of the imaging optical system illustrated in FIG. 1;

FIG. 13 is an explanatory diagram of an imaging device according to a third embodiment;

FIG. 14 is a diagram illustrating data of an imaging optical system of the third embodiment;

FIG. 15 is a diagram illustrating spherical aberrations of the imaging optical system illustrated in FIG. 13;

FIG. 16 is a diagram illustrating chromatic aberrations of magnification of the imaging optical system illustrated in FIG. 13;

FIG. 17 is a diagram illustrating astigmatisms and distortions of the imaging optical system illustrated in FIG. 13;

FIG. 18 is a diagram illustrating lateral aberrations of the imaging optical system illustrated in FIG. 13;

FIG. 19 is an explanatory diagram of an imaging device according to a fourth embodiment;

FIG. 20 is a diagram illustrating data of an imaging optical system of the fourth embodiment;

FIG. 21 is a diagram illustrating spherical aberrations of the imaging optical system illustrated in FIG. 19;

FIG. 22 is a diagram illustrating chromatic aberrations of magnification of the imaging optical system illustrated in FIG. 19;

FIG. 23 is a diagram illustrating astigmatisms and distortions of the imaging optical system illustrated in FIG. 19;

FIG. 24 is a diagram illustrating lateral aberrations of the imaging optical system illustrated in FIG. 19;

FIG. 25 is an explanatory diagram of an imaging device according to a fifth embodiment;

FIG. 26 is a diagram illustrating data of an imaging optical system of the fifth embodiment;

FIG. 27 is a diagram illustrating spherical aberrations of the imaging optical system illustrated in FIG. 25;

FIG. 28 is a diagram illustrating chromatic aberrations of magnification of the imaging optical system illustrated in FIG. 25;

FIG. 29 is a diagram illustrating astigmatisms and distortions of the imaging optical system illustrated in FIG. 25; and

FIG. 30 is a diagram illustrating lateral aberrations of the imaging optical system illustrated in FIG. 25.

### DETAILED DESCRIPTION

Hereinafter, embodiments of an imaging device 200 including an imaging optical system 100 to which at least an embodiment of the disclosure is applied are described. The imaging device 200 is used in an in-vehicle camera or a monitoring camera. In particular, the imaging optical system 100 is suitable for use in a monitoring camera for monitoring the interior of a vehicle.

### First Embodiment

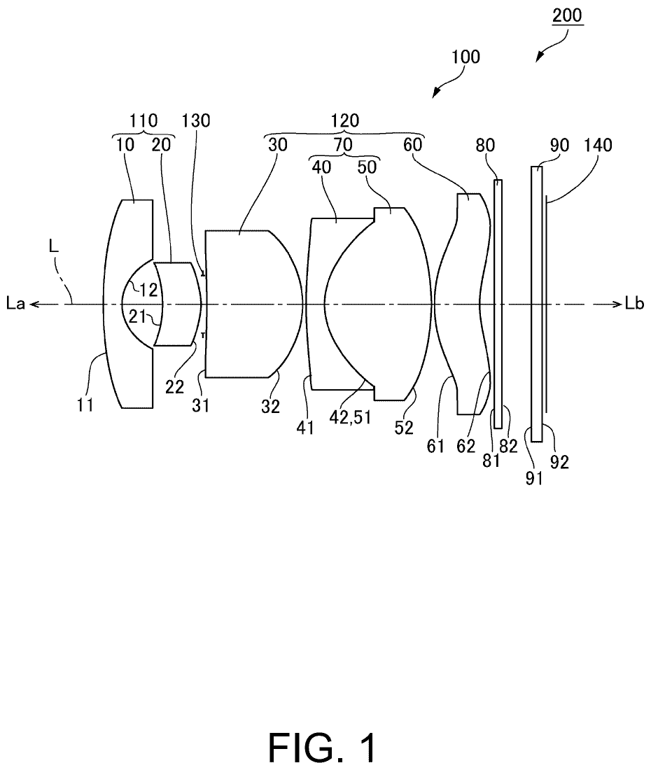

FIG. 1 is an explanatory diagram of an imaging device 200 according to a first embodiment. As illustrated in FIG. 1, the imaging device 200 of the present embodiment includes an imaging optical system 100, and an imaging element 140. The imaging optical system 100 includes, in order from an object side La toward an image side Lb, a front group 110, a diaphragm 130, a rear group 120, and an infrared cut filter 80.

The front group 110 is constituted of, in order from the object side La toward the image side Lb, a first lens 10 and a second lens 20. The rear group 120 is constituted of, in order from the object side La toward the image side Lb, a third lens 30, a fourth lens 40, a fifth lens 50, and a sixth lens 60. The fourth lens 40 and the fifth lens 50 are a cemented lens 70 bonded with an adhesive. On the image side Lb of the sixth lens 60, the flat infrared cut filter 80, a translucent cover 90, and the imaging element 140 are disposed in order from the object side La toward the image side Lb. The imaging element 140 is disposed on an imaging plane on the image side Lb of the imaging optical system 100.

The first lens 10 is made of resin. The first lens 10 has a negative power. The first lens 10 has a convex shape on a lens surface 11 on the object side La, and has a concave shape on a lens surface 12 on the image side Lb. The first lens 10 has an aspherical shape on both surfaces thereof.

The second lens 20 is made of resin. The second lens 20 has a positive power. The second lens 20 has a concave shape on a lens surface 21 on the object side La, and has a convex shape on a lens surface 22 on the image side Lb. The second lens 20 has an aspherical shape on both surfaces thereof.

The third lens 30 is made of glass. The third lens 30 has a positive power. The third lens 30 has a concave shape on a lens surface 31 on the object side La, and has a convex shape on a lens surface 32 on the image side Lb.

The fourth lens 40 is made of resin. The fourth lens 40 has a negative power. The fourth lens 40 has a convex shape on a lens surface 41 on the object side La, and has a concave shape on a lens surface 42 on the image side Lb. The fourth lens 40 has an aspherical shape on both surfaces thereof.

The fifth lens 50 is made of resin. The fifth lens 50 has a positive power. The fifth lens 50 has a convex shape on a lens surface 51 on the object side La, and has a convex shape on a lens surface 52 on the image side Lb. The fifth lens 50 has an aspherical shape on both surfaces thereof.

The sixth lens 60 is made of resin. The sixth lens 60 has a positive power. The sixth lens 60 has a convex shape on a lens surface 61 on the object side La, and has a concave shape on a lens surface 62 on the image side Lb. The sixth lens 60 has an aspherical shape on both surfaces thereof.

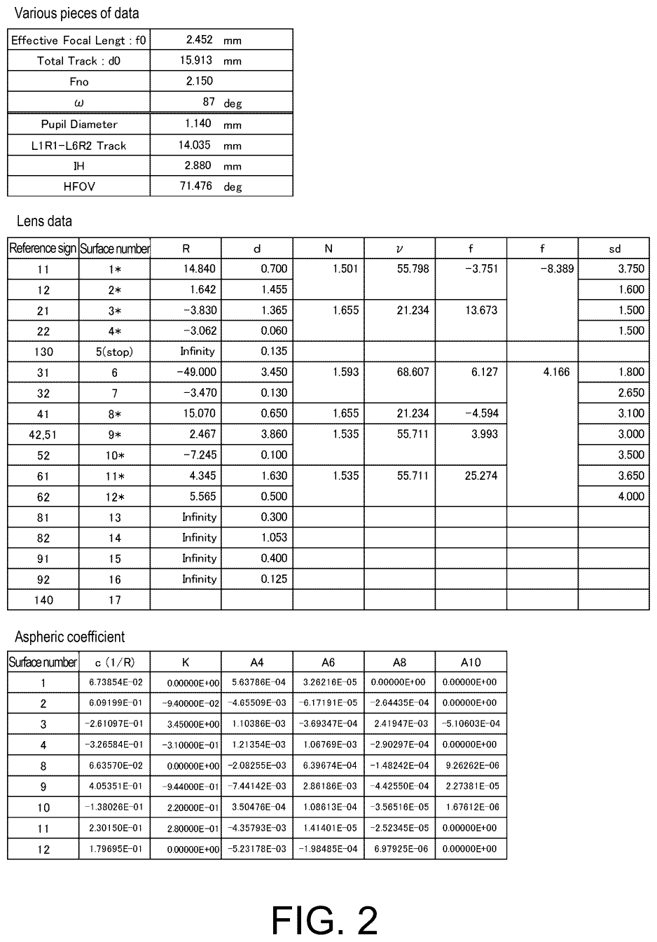

FIG. 2 is a diagram illustrating data of the imaging optical system 100 in the first embodiment. Note that, values indicated in FIG. 2 are obtained by rounding.

FIG. 2 indicates the following various pieces of data. Herein, in the various pieces of data, the entire length of the entire lens system is a distance, on an optical axis L, from the lens surface 11 on the object side La of the first lens 10 to the imaging plane of the imaging element 140. The entire length between the first lens and the sixth lens is a distance, on the optical axis L, from the lens surface 11 on the object side La of the first lens 10 to the lens surface 62 on the image side Lb of the sixth lens.
Focal length of the entire lens system (Effective Focal Length: f0)
Entire length of the entire lens system (Total Track: d0)
F-number (Fno) of the entire lens system
Maximum half angle of view (ω)
Pupil Diameter
Entire length (L1R1−L6R2 Track) between the first lens and the sixth lens
Viewing angle (HFOV) in a horizontal direction

Further, FIG. 2 indicates lens data of the following lenses. In the lens data, a surface denoted by a surface number with * is an aspherical surface. R is a radius of curvature. d is a surface interval. N is a refractive index. v is the Abbe number. f is a focal length. sd is an effective radius. The unit of the radius of curvature, the surface interval, and the focal length is mm. In addition, FIG. 2 indicates an aspheric coefficient indicating a shape of an aspherical surface for each surface number.

When it is assumed that the viewing angle in the horizontal direction is HFOV, the entire length between the lenses of the front group 110 is df, and the entire length between the lenses of the rear group 120 is dr, the imaging optical system 100 satisfies the following conditional expressions:

$$100 < HFOV \qquad ( 1 )$$

$$df / dr < 0.58 \qquad ( 2 )$$

More preferably, the imaging optical system 100 satisfies the following conditional expression:

$$1 \; 00 < HFOV < 160 \qquad ( 1 A )$$

More preferably, the imaging optical system 100 satisfies the following conditional expression:

$$0.2 < df / dr < 0.580 \qquad ( 8 )$$

Furthermore preferably, the imaging optical system 100 satisfies the following conditional expression:

$$0.35 < df / dr < 0.400$$

In the present embodiment,

$$HFOV = 142.951$$

$$df = 3.520$$

$$dr = 9.820$$

Therefore, HFOV=142.951, and the imaging optical system 100 satisfies the conditional expressions (1) and (1A). df/dr=0.358, and the imaging optical system 100 satisfies the conditional expressions (2) and (8).

When it is assumed that the thickness of the third lens 30 is T3, and the focal length of the entire lens system is f0, the imaging optical system 100 satisfies the following conditional expressions:

$$1. < T 3 / f 0 < 2.000 \qquad ( 3 )$$

In the present embodiment,

$$T 3 = 3 \text{.450}$$

$$f 0 = 2.452$$

Therefore, T3/f0=1.407, and the imaging optical system 100 satisfies the conditional expression (3).

When it is assumed that the radius of curvature of the lens surface 31 on the object side of the third lens 30 is R31, and the radius of curvature of the lens surface 32 on the image side of the third lens is R32, the imaging optical system 100 satisfies the following conditional expression:

$$1. < ( R 31 + R 32 ) / ( R 31 - R 32 ) < 1.500 \qquad ( 4 )$$

More preferably, the imaging optical system 100 satisfies the following conditional expression:

$$1. < ( R 31 + R 32 ) / ( R 31 - R 32 ) < 1.300$$

In the present embodiment,

$$R 31 = - 49 \text{.000}$$

$$R 32 = - 3.47$$

Therefore, (R31+R32)/(R31−R32)=1.152, and the imaging optical system 100 satisfies the conditional expression (4).

When it is assumed that the focal length of the entire lens system is f0, and the focal length of the third lens 30 is f3, the imaging optical system 100 satisfies the following conditional expression:

$$1.8 < f 3 / f 0 < 4. \qquad ( 5 )$$

In the present embodiment,

$$f 3 = 6.127$$

$$f 0 = 2.452$$

Therefore, f3/f0=2.499, and the imaging optical system 100 satisfies the conditional expression (5).

When it is assumed that the entire length of the entire lens system is d0, and the effective radius of the lens surface 11 on the object side of the first lens 10 is sd11, the imaging optical system 100 satisfies the following conditional expression:

$$3. < d 0 / sd 11 < 5.5 \qquad ( 6 )$$

More preferably, the imaging optical system 100 satisfies the following conditional expression:

$$3.5 < d 0 / sd 11 < 4.5$$

In the present embodiment,

$$d 0 = 15.913$$

$$sd 11 = 3.75$$

Therefore, d0/sd11=4.243, and the imaging optical system 100 satisfies the conditional expression (6).

When it is assumed that the focal length of the entire lens system is f0, and the entire length of the entire lens system is d0, the imaging optical system 100 satisfies the following conditional expression:

$$5.5 < d 0 / f 0 < 9. \qquad ( 7 )$$

In the present embodiment,

$$d 0 = 15.913$$

$$f 0 = 2.452$$

Therefore, d0/f0=6.490, and the imaging optical system 100 satisfies the conditional expression (7).

When it is assumed that the entire length of the entire lens system is d0, and the maximum image height is IH, the imaging optical system 100 satisfies the following conditional expression:

$$2. < d 0 / IH < 4. \qquad ( 9 )$$

In the present embodiment,

$$d 0 = 15.913$$

$$IH = 2.88$$

Therefore, d0/IH=5.525, and the imaging optical system 100 satisfies the conditional expression (9).

### Advantageous Effects

Since the imaging optical system 100 of the present embodiment satisfies the conditional expression (1) and satisfies the conditional expression (2), the imaging optical system 100 has a wide angle, and it is possible to appropriately correct various aberrations, while suppressing an increase in the outer diameter of the first lens 10. In a case where the conditional expression (1) is satisfied, when the value of the conditional expression (2) exceeds the upper limit, and if the entire length dr between the lenses of the rear group 120 becomes smaller than the entire length df between the lenses of the front group 110, the outer diameter of the first lens 10 becomes too large. In addition, if the entire length dr between the lenses of the rear group 120 becomes smaller than the entire length df between the lenses of the front group 110, various aberrations cannot be satisfactorily corrected in the rear group 120. Further, in a case where the value of the conditional expression (1A) exceeds the upper limit, the imaging optical system 100 can achieve a super-wide angle, but various aberrations increase, which deteriorates the optical performances. Further, in a case where the value of the conditional expression (8) falls below the lower limit, various aberrations can be satisfactorily corrected in the rear group 120, but the entire length of the entire lens system increases.

Since the imaging optical system 100 of the present embodiment satisfies the conditional expression (3), it is possible to appropriately correct various aberrations by suppressing the angle of a light beam emitted from the third lens 30 adjacent to the diaphragm 130. In a case where the value of the conditional expression (3) falls below the lower limit, the thickness of the third lens 30 becomes small, which increases the angle of a light beam emitted from the third lens 30. This makes it impossible to satisfactorily correct various aberrations in the rear group 120. In a case where the value of the conditional expression (3) exceeds the upper limit, various aberrations can be satisfactorily corrected in the rear group 120, but the thickness of the third lens 30 increases, which increases the entire length of the entire lens system.

The third lens 30 has a concave shape on the lens surface 31 on the object side La, and has a convex shape on the lens surface 32 on the image side Lb. This enables to increase the optical path length in the third lens 30, which enables to suppress the angle of a light beam emitted from the third lens 30. Consequently, various aberrations can be satisfactorily corrected in the rear group 120. Further, since the third lens 30 has a concave shape on the lens surface 31 on the object side La, it is possible to make the outer peripheral surface of a flange portion, which is an outer peripheral portion, into a straight surface being in parallel to the optical axis L when forming the third lens 30. Consequently, aligning the third lens 30 with the direction of the optical axis L is made easy when assembling the third lens 30 into a lens barrel.

The third lens 30 is made of glass. The first lens 10, the second lens 20, the fourth lens 40, the fifth lens 50, and the sixth lens 60 are made of resin. This provides satisfactory temperature characteristics of the imaging optical system 100.

Since the imaging optical system 100 of the present embodiment is configured in such a way that the third lens 30 has a positive power, and the imaging optical system 100 satisfies the conditional expression (4), it is possible to make the lens surface 31 into a concave shape, make the lens surface 32 into a convex shape, and suppress lowering in optical characteristics due to a temperature change of the imaging optical system 100. In a case where the value of the conditional expression (4) exceeds the upper limit, power of the third lens 30 decreases, which makes it impossible to satisfactorily correct the temperature characteristics of the imaging optical system 100.

Since the imaging optical system 100 of the present embodiment satisfies the conditional expression (5), it is possible to appropriately correct various aberrations. In a case where the value of the conditional expression (5) falls below the lower limit, power of the third lens 30 excessively increases, which makes it difficult to suppress occurrence of various aberrations. In a case where the value of the conditional expression (3) exceeds the upper limit, power of the third lens 30 decreases, therefore, occurrence of various aberrations can be suppressed, but the entire length of the entire lens system is likely to increase.

Since the imaging optical system 100 of the present embodiment satisfies the conditional expression (6), it is possible to satisfactorily correct various aberrations, and the entire length of the entire lens system decreases. In a case where the value of the conditional expression (6) falls below the lower limit, the angle of a light beam incident into the imaging element 140 increases, which makes it impossible to satisfactorily correct various aberrations. In a case where the value of the conditional expression (6) exceeds the upper limit, it is possible to satisfactorily correct various aberrations, but the entire length of the entire lens system increases.

Since the imaging optical system 100 of the present embodiment satisfies the conditional expression (7), it is possible to suppress an increase in the entire length of the entire lens system, and it is possible to suppress occurrence of various aberrations. In a case where the value of the conditional expression (7) falls below the lower limit, it is not easy to suppress occurrence of various aberrations. In a case where the value of the conditional expression (7) exceeds the upper limit, the size of each lens system is likely to increase, and the entire length of the entire lens system is likely to increase.

Since the imaging optical system 100 of the present embodiment satisfies the conditional expression (9), it is possible to satisfactorily correct various aberrations, and the entire length of the entire lens system decreases. In a case where the value of the conditional expression (9) falls below the lower limit, the angle of a light beam incident into the imaging element 140 increases, which makes it impossible to satisfactorily correct various aberrations. In a case where the value of the conditional expression (9) exceeds the upper limit, it is possible to satisfactorily correct various aberrations, but the entire length of the entire lens system increases.

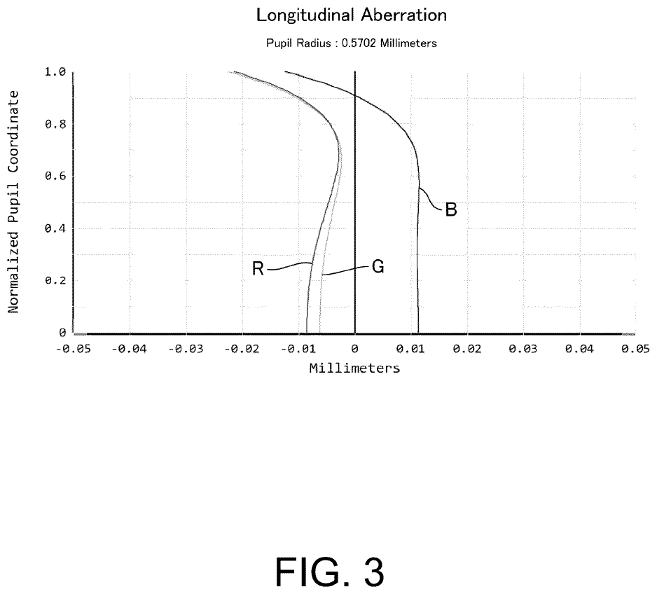

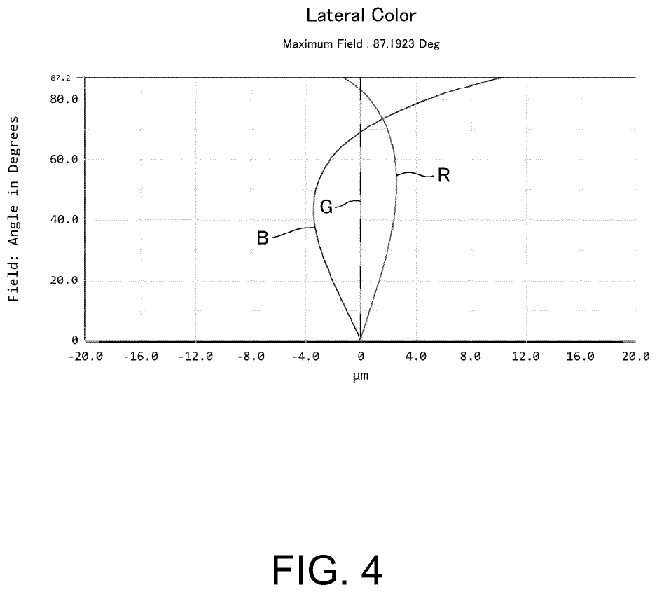

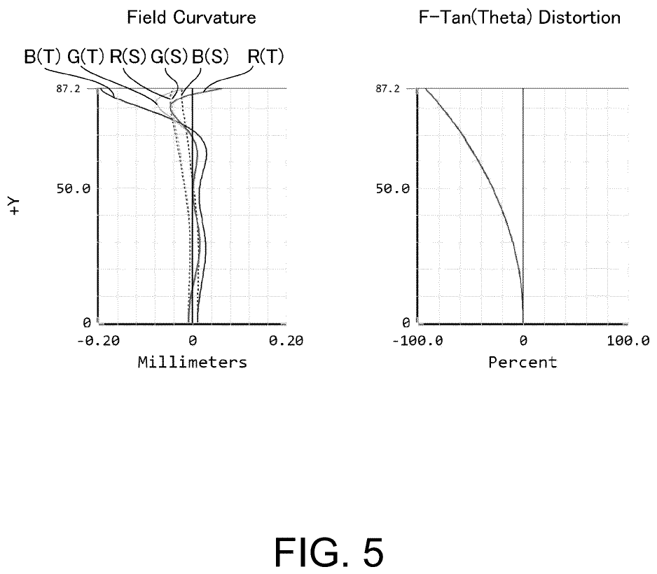

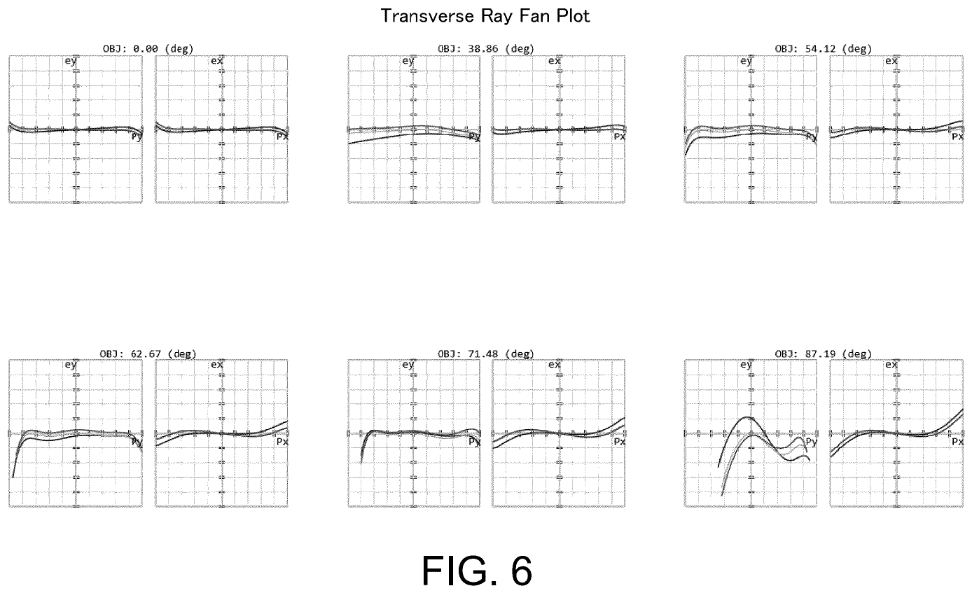

FIG. 3 is a diagram illustrating spherical aberrations of the imaging optical system 100 illustrated in FIG. 1. FIG. 4 is a diagram illustrating chromatic aberrations of magnification of the imaging optical system 100 illustrated in FIG. 1, and indicates chromatic aberrations of magnification at a maximum half angle of view. FIG. 5 is a diagram illustrating astigmatisms and distortions of the imaging optical system 100 illustrated in FIG. 1. FIG. 6 is a diagram illustrating lateral aberrations of the imaging optical system 100 illustrated in FIG. 1, and indicates lateral aberrations in a tangential direction (Y direction) and in a sagittal direction (X direction).

Note that, in FIGS. 3 to 6, aberrations at a wavelength of 486 nm, 588 nm, and 656 nm are denoted by B, G, and R, respectively. Concerning the astigmatisms illustrated in FIG. 5, characteristics in the sagittal direction are denoted by S, and characteristics in the tangential direction are denoted by T.

As illustrated in FIGS. 3 to 6, in the imaging optical system 100 of the present embodiment, spherical aberrations, chromatic aberrations of magnification, astigmatisms (distortions), and lateral aberrations are corrected to an appropriate level.

### Second Embodiment

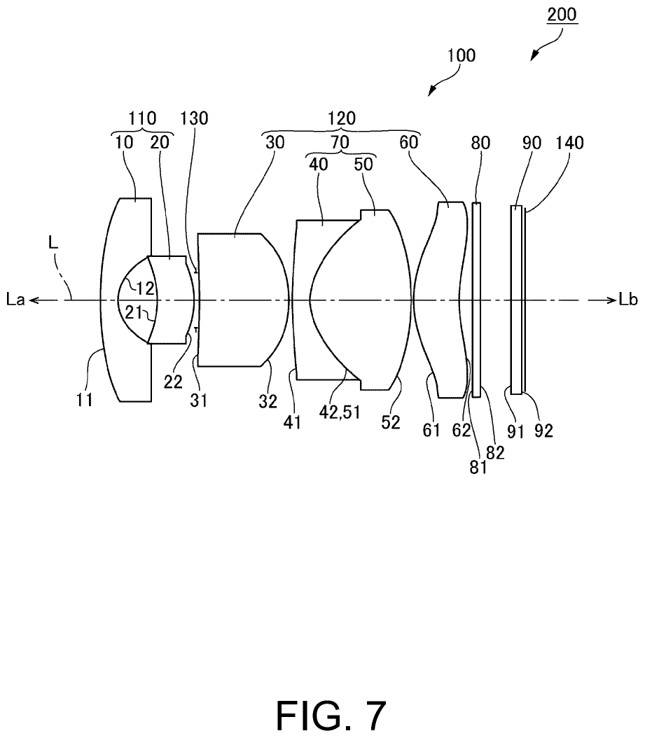

FIG. 7 is an explanatory diagram of an imaging device 200 according to a second embodiment. As illustrated in FIG. 7, the imaging device 200 of the present embodiment includes an imaging optical system 100, and an imaging element 140. The imaging optical system 100 includes, in order from an object side La toward an image side Lb, a front group 110, a diaphragm 130, a rear group 120, and an infrared cut filter 80.

The front group 110 is constituted of, in order from the object side La toward the image side Lb, a first lens 10 and a second lens 20. The rear group 120 is constituted of, in order from the object side La toward the image side Lb, a third lens 30, a fourth lens 40, a fifth lens 50, and a sixth lens 60. The fourth lens 40 and the fifth lens 50 are a cemented lens 70 bonded with an adhesive. On the image side Lb of the sixth lens 60, the flat infrared cut filter 80, a translucent cover 90, and the imaging element 140 are disposed in order from the object side La toward the image side Lb. The imaging element 140 is disposed on an imaging plane on the image side Lb of the imaging optical system 100.

The first lens 10 is made of resin. The first lens 10 has a negative power. The first lens 10 has a convex shape on a lens surface 11 on the object side La, and has a concave shape on a lens surface 12 on the image side Lb. The first lens 10 has an aspherical shape on the lens surface 12.

The second lens 20 is made of resin. The second lens 20 has a positive power. The second lens 20 has a concave shape on a lens surface 21 on the object side La, and has a convex shape on a lens surface 22 on the image side Lb. The second lens 20 has an aspherical shape on both surfaces thereof.

The third lens 30 is made of glass. The third lens 30 has a positive power. The third lens 30 has a concave shape on a lens surface 31 on the object side La, and has a convex shape on a lens surface 32 on the image side Lb.

The fourth lens 40 is made of resin. The fourth lens 40 has a negative power. The fourth lens 40 has a convex shape on a lens surface 41 on the object side La, and has a concave shape on a lens surface 42 on the image side Lb. The fourth lens 40 has an aspherical shape on both surfaces thereof.

The fifth lens 50 is made of resin. The fifth lens 50 has a positive power. The fifth lens 50 has a convex shape on a lens surface 51 on the object side La, and has a convex shape on a lens surface 52 on the image side Lb. The fifth lens 50 has an aspherical shape on both surfaces thereof.

The sixth lens 60 is made of resin. The sixth lens 60 has a positive power. The sixth lens 60 has a convex shape on a lens surface 61 on the object side La, and has a concave shape on a lens surface 62 on the image side Lb. The sixth lens 60 has an aspherical shape on both surfaces thereof.

### Lens Configuration

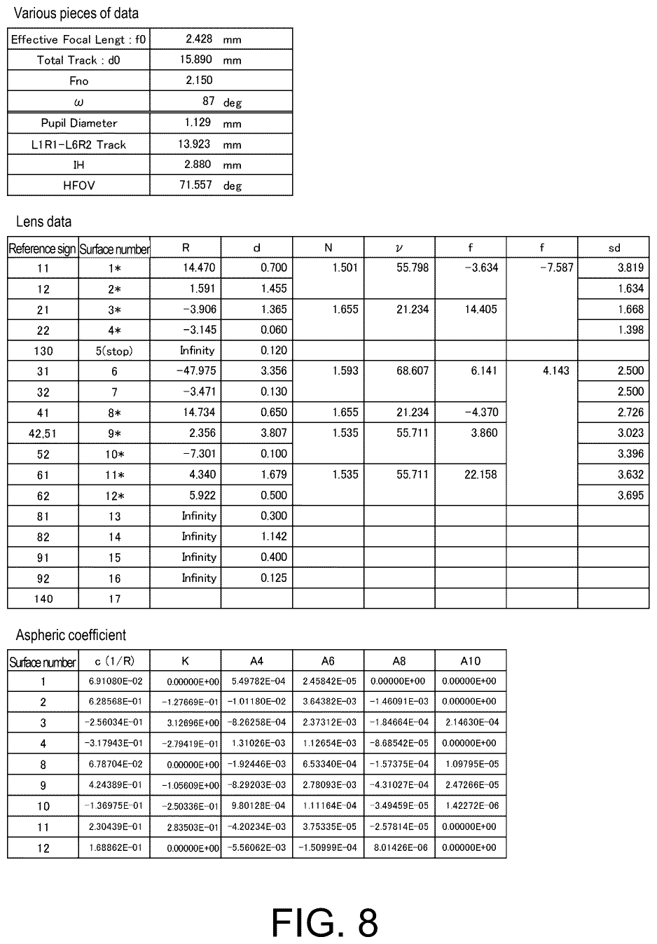

FIG. 8 is a diagram illustrating data of the imaging optical system 100 in the second embodiment. The imaging optical system 100 of the present embodiment satisfies the conditional expressions (1) to (9) described in the first embodiment.

In the present embodiment,

$$HFOV = 143.114$$

$$df = 3.52$$

$$dr = 9.723$$

Therefore, HFOV=143.114, and the imaging optical system 100 satisfies the conditional expressions (1) and (1A). df/dr=0.362, and the imaging optical system 100 satisfies the conditional expressions (2) and (8).

In the present embodiment,

$$T 3 = 3.356$$

$$f 0 = 2.428$$

Therefore, T3/f0=1.382, and the imaging optical system 100 satisfies the conditional expression (3).

In the present embodiment,

$$R 31 = - 47.975$$

$$R 32 = - 3.471$$

Therefore, (R31+R32)/(R31−R32)=1.156, and the imaging optical system 100 satisfies the conditional expression (4).

In the present embodiment,

$$f 3 = 6.141$$

$$f 0 = 2.428$$

Therefore, f3/f0=2.529, and the imaging optical system 100 satisfies the conditional expression (5).

In the present embodiment,

$$d 0 = 15.89$$

$$sd 11 = 3.819$$

Therefore, d0/sd11=4.160, and the imaging optical system 100 satisfies the conditional expression (6).

In the present embodiment,

$$d 0 = 15.89$$

$$f 0 = 2.428$$

Therefore, d0/f0=6.543, and the imaging optical system 100 satisfies the conditional expression (7).

In the present embodiment,

$$d 0 = 15 \text{.890}$$

$$I H = 2.880$$

Therefore, d0/IH=5.517, and the imaging optical system 100 satisfies the conditional expression (9).

### Advantageous Effects

Since the imaging optical system 100 of the second embodiment satisfies the conditional expressions (1) to (9) similarly to the first embodiment, the imaging optical system 100 can provide advantageous effects similar to those of the first embodiment.

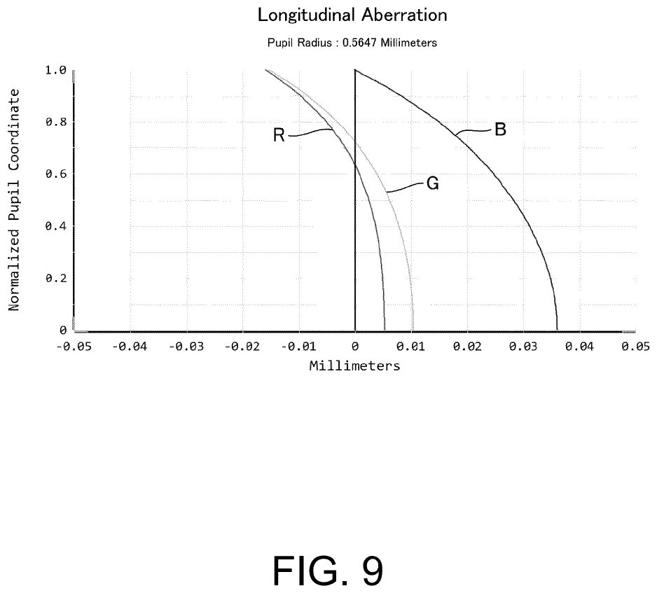

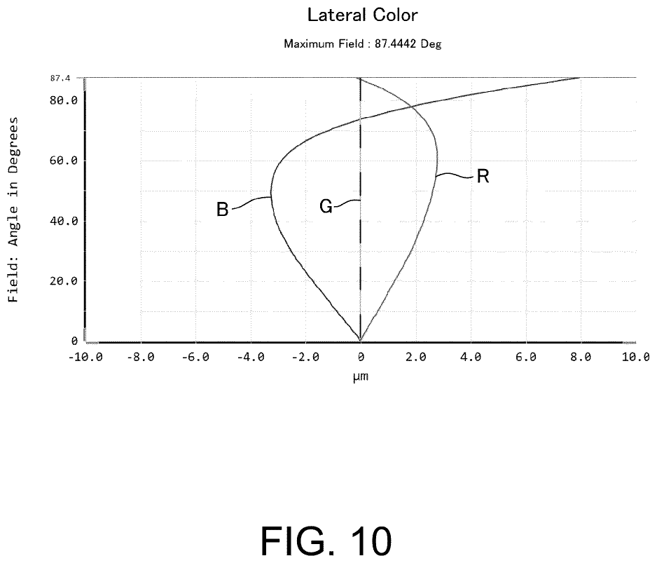

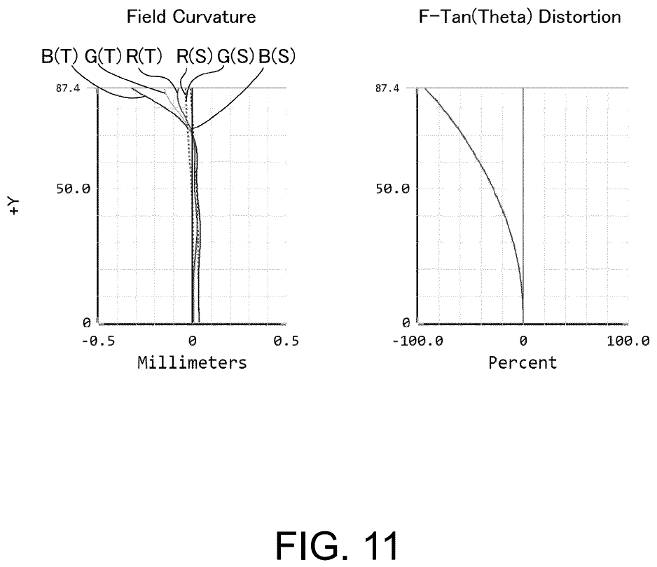

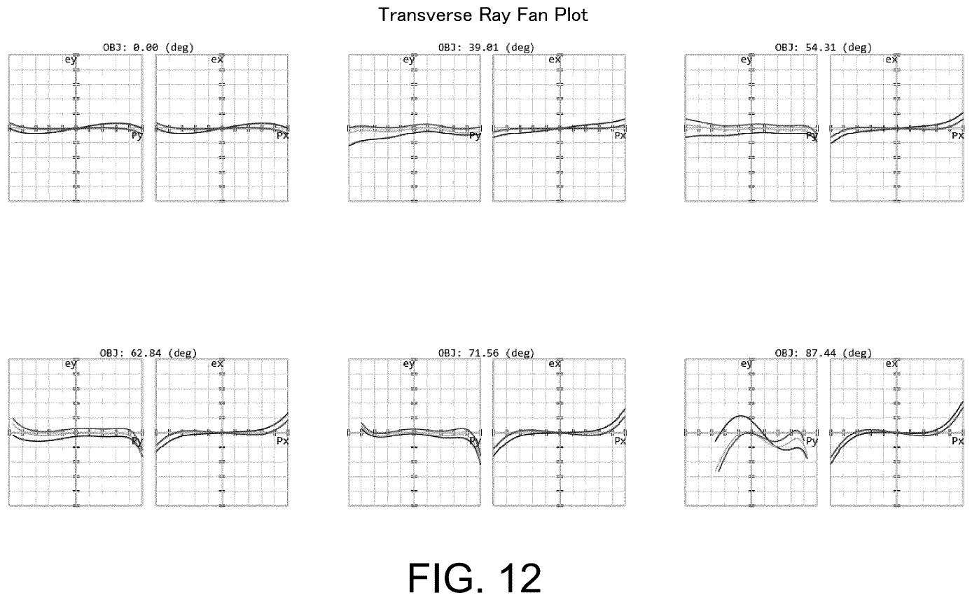

FIG. 9 is a diagram illustrating spherical aberrations of the imaging optical system 100 illustrated in FIG. 7. FIG. 10 is a diagram illustrating chromatic aberrations of magnification of the imaging optical system 100 illustrated in FIG. 7. FIG. 11 is a diagram illustrating astigmatisms and distortions of the imaging optical system 100 illustrated in FIG. 7. FIG. 12 is a diagram illustrating lateral aberrations of the imaging optical system 100 illustrated in FIG. 7.

As illustrated in FIGS. 9 to 12, in the imaging optical system 100 of the present embodiment, spherical aberrations, chromatic aberrations of magnification, astigmatisms (distortions), lateral aberrations, and resolutions are corrected to an appropriate level.

### Third Embodiment

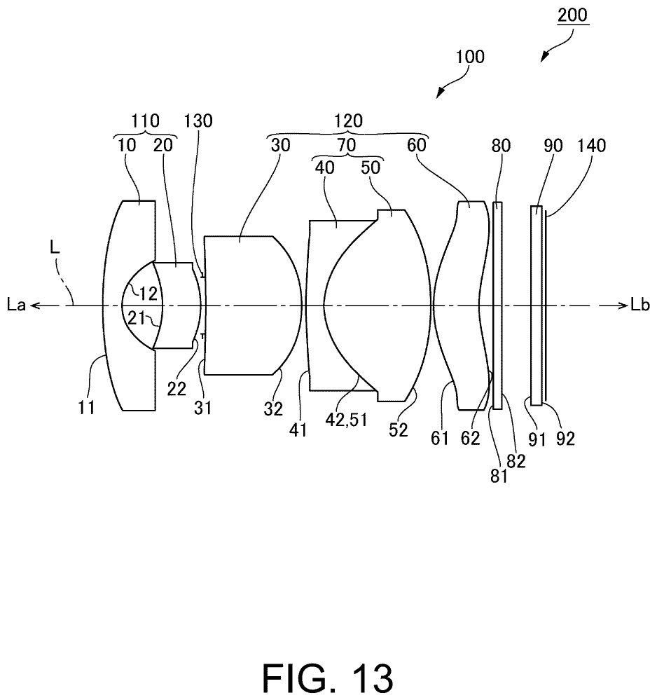

FIG. 13 is an explanatory diagram of an imaging device 200 according to a third embodiment. As illustrated in FIG. 13, the imaging device 200 of the present embodiment includes an imaging optical system 100, and an imaging element 140. The imaging optical system 100 includes, in order from an object side La toward an image side Lb, a front group 110, a diaphragm 130, a rear group 120, and an infrared cut filter 80.

The front group 110 is constituted of, in order from the object side La toward the image side Lb, a first lens 10 and a second lens 20. The rear group 120 is constituted of, in order from the object side La toward the image side Lb, a third lens 30, a fourth lens 40, a fifth lens 50, and a sixth lens 60. The fourth lens 40 and the fifth lens 50 are a cemented lens 70 bonded with an adhesive. On the image side Lb of the sixth lens 60, the flat infrared cut filter 80, a translucent cover 90, and the imaging element 140 are disposed in order from the object side La toward the image side Lb. The imaging element 140 is disposed on an imaging plane on the image side Lb of the imaging optical system 100.

The first lens 10 is made of resin. The first lens 10 has a negative power. The first lens 10 has a convex shape on a lens surface 11 on the object side La, and has a concave shape on a lens surface 12 on the image side Lb. The first lens 10 has an aspherical shape on the lens surface 12.

The second lens 20 is made of resin. The second lens 20 has a positive power. The second lens 20 has a concave shape on a lens surface 21 on the object side La, and has a convex shape on a lens surface 22 on the image side Lb. The second lens 20 has an aspherical shape on both surfaces thereof.

The third lens 30 is made of glass. The third lens 30 has a positive power. The third lens 30 has a concave shape on a lens surface 31 on the object side La, and has a convex shape on a lens surface 32 on the image side Lb.

The fourth lens 40 is made of resin. The fourth lens 40 has a negative power. The fourth lens 40 has a convex shape on a lens surface 41 on the object side La, and has a concave shape on a lens surface 42 on the image side Lb. The fourth lens 40 has an aspherical shape on both surfaces thereof.

The fifth lens 50 is made of resin. The fifth lens 50 has a positive power. The fifth lens 50 has a convex shape on a lens surface 51 on the object side La, and has a convex shape on a lens surface 52 on the image side Lb. The fifth lens 50 has an aspherical shape on both surfaces thereof.

The sixth lens 60 is made of resin. The sixth lens 60 has a positive power. The sixth lens 60 has a convex shape on a lens surface 61 on the object side La, and has a concave shape on a lens surface 62 on the image side Lb. The sixth lens 60 has an aspherical shape on both surfaces thereof.

### Lens Configuration

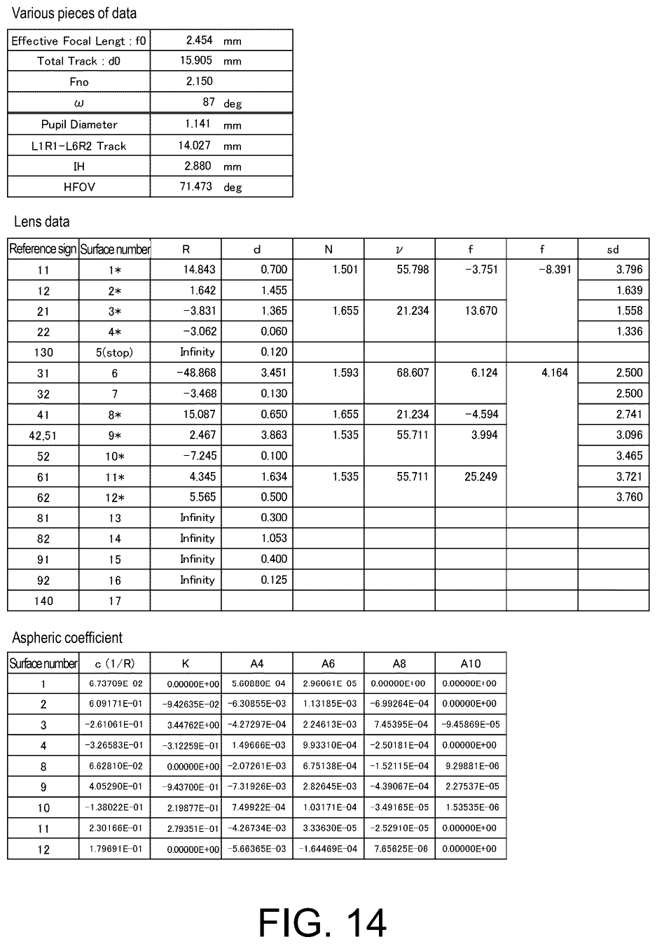

FIG. 14 is a diagram illustrating data of the imaging optical system 100 in the third embodiment. The imaging optical system 100 of the present embodiment satisfies the conditional expressions (1) to (9) described in the first embodiment.

In the present embodiment,

$$H F O V = 142.947$$

$$df = 3.5 \; 20$$

$$dr = 9.827$$

Therefore, HFOV=142.947, and the imaging optical system 100 satisfies the conditional expressions (1) and (1A). df/dr=0.358, and the imaging optical system 100 satisfies the conditional expressions (2) and (8).

In the present embodiment,

$$T 3 = 3 \text{.451}$$

$$f 0 = 2.454$$

Therefore, T3/f0=1.407, and the imaging optical system 100 satisfies the conditional expression (3).

In the present embodiment,

$$R 31 = - 48 \text{.868}$$

$$R 32 = - 3.468$$

Therefore, (R31+R32)/(R31−R32)=1.153, and the imaging optical system 100 satisfies the conditional expression (4).

In the present embodiment,

$$f 3 = 6 \text{.124}$$

$$f 0 = 2.454$$

Therefore, f3/f0=2.496, and the imaging optical system 100 satisfies the conditional expression (5).

In the present embodiment,

$$d 0 = 15 \text{.905}$$

$$sd 11 = 3.796$$

Therefore, d0/sd11=4.190, and the imaging optical system 100 satisfies the conditional expression (6).

In the present embodiment,

$$d 0 = 15 \text{.905}$$

$$f 0 = 2.454$$

Therefore, d0/f0=6.483, and the imaging optical system 100 satisfies the conditional expression (7).

In the present embodiment,

$$d 0 = 15 \text{.905}$$

$$I H = 2.880$$

Therefore, d0/IH=5.523, and the imaging optical system 100 satisfies the conditional expression (9).

### Advantageous Effects

Since the imaging optical system 100 of the third embodiment satisfies the conditional expressions (1) to (9) similarly to the first embodiment, the imaging optical system 100 can provide advantageous effects similar to those of the first embodiment.

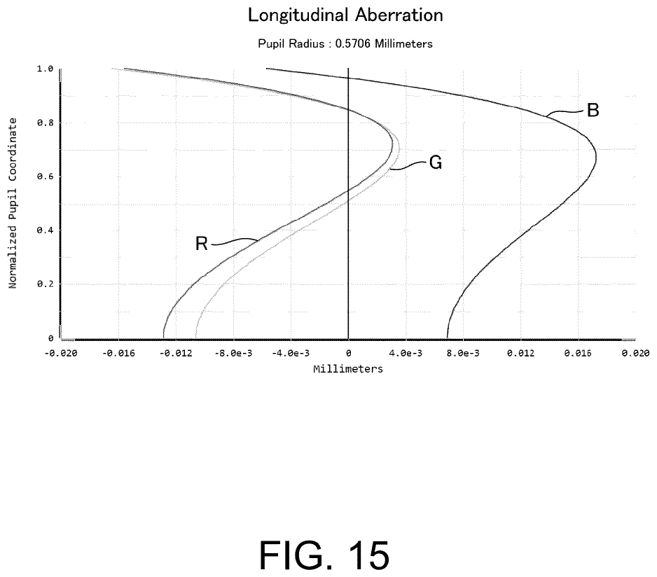

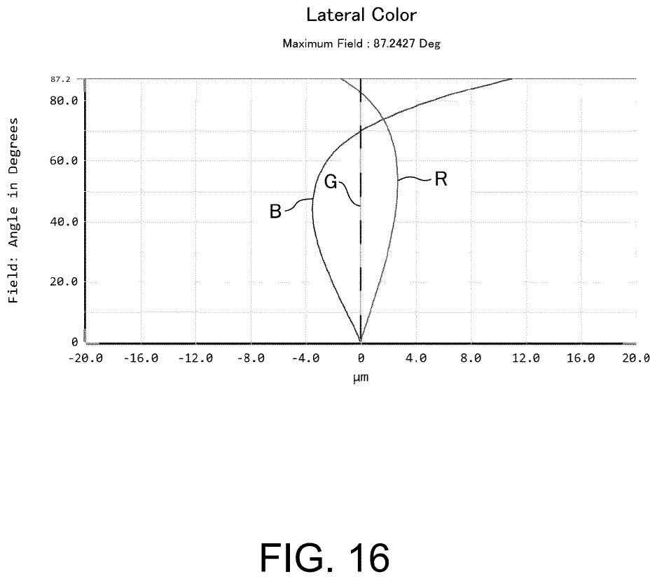

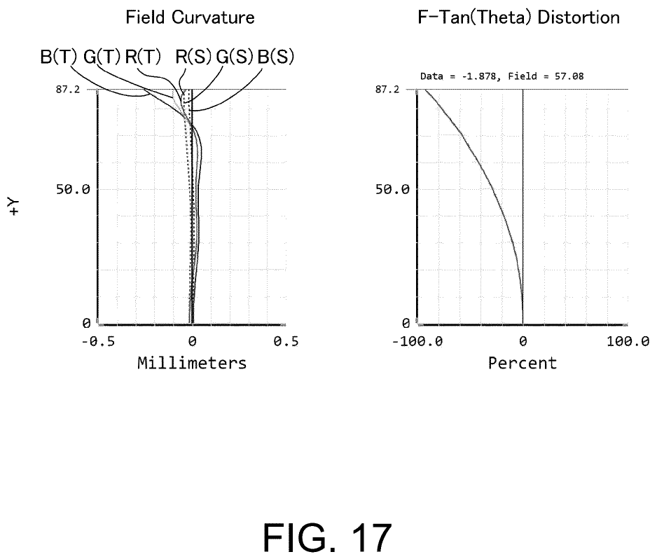

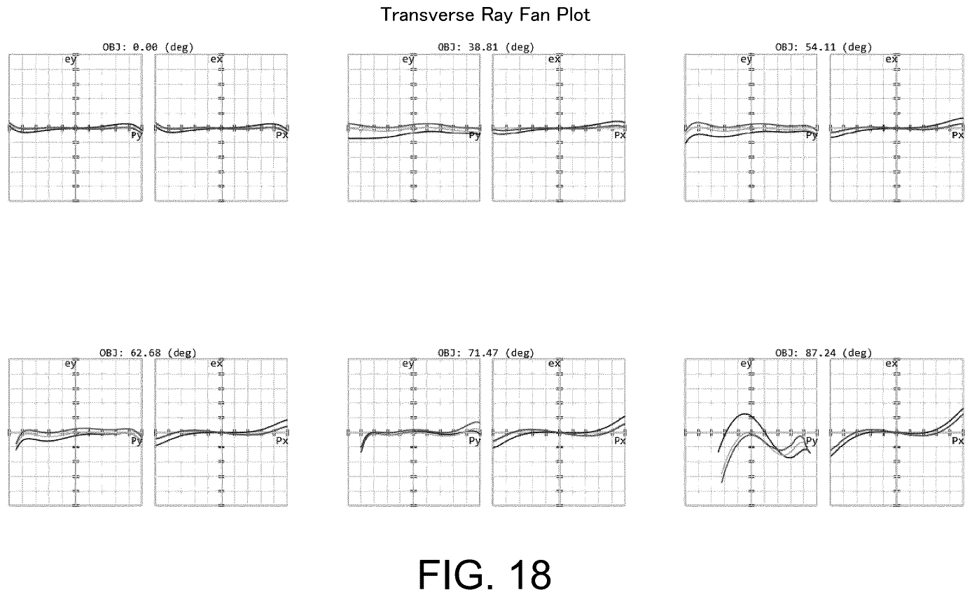

FIG. 15 is a diagram illustrating spherical aberrations of the imaging optical system 100 illustrated in FIG. 13. FIG. 16 is a diagram illustrating chromatic aberrations of magnification of the imaging optical system 100 illustrated in FIG. 13. FIG. 17 is a diagram illustrating astigmatisms and distortions of the imaging optical system 100 illustrated in FIG. 13. FIG. 18 is a diagram illustrating lateral aberrations of the imaging optical system 100 illustrated in FIG. 13.

As illustrated in FIGS. 15 to 18, in the imaging optical system 100 of the present embodiment, spherical aberrations, chromatic aberrations of magnification, astigmatisms (distortions), lateral aberrations, and resolutions are corrected to an appropriate level.

### Fourth Embodiment

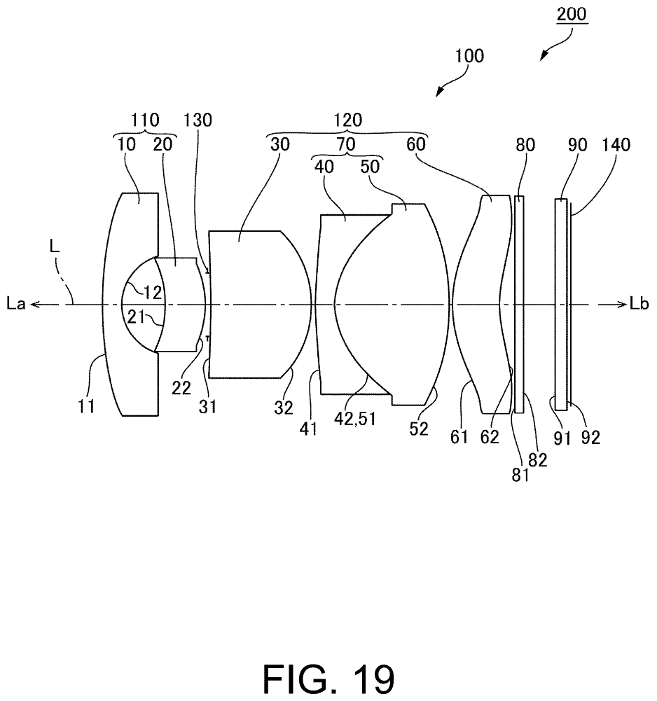

FIG. 19 is an explanatory diagram of an imaging device 200 according to a fourth embodiment. As illustrated in FIG. 19, the imaging device 200 of the present embodiment includes an imaging optical system 100, and an imaging element 140. The imaging optical system 100 includes, in order from an object side La toward an image side Lb, a front group 110, a diaphragm 130, a rear group 120, and an infrared cut filter 80.

The front group 110 is constituted of, in order from the object side La toward the image side Lb, a first lens 10 and a second lens 20. The rear group 120 is constituted of, in order from the object side La toward the image side Lb, a third lens 30, a fourth lens 40, a fifth lens 50, and a sixth lens 60. The fourth lens 40 and the fifth lens 50 are a cemented lens 70 bonded with an adhesive. On the image side Lb of the sixth lens 60, the flat infrared cut filter 80, a translucent cover 90, and the imaging element 140 are disposed in order from the object side La toward the image side Lb. The imaging element 140 is disposed on an imaging plane on the image side Lb of the imaging optical system 100.

The first lens 10 is made of resin. The first lens 10 has a negative power. The first lens 10 has a convex shape on a lens surface 11 on the object side La, and has a concave shape on a lens surface 12 on the image side Lb. The first lens 10 has an aspherical shape on the lens surface 12.

The second lens 20 is made of resin. The second lens 20 has a positive power. The second lens 20 has a concave shape on a lens surface 21 on the object side La, and has a convex shape on a lens surface 22 on the image side Lb. The second lens 20 has an aspherical shape on both surfaces thereof.

The third lens 30 is made of glass. The third lens 30 has a positive power. The third lens 30 has a concave shape on a lens surface 31 on the object side La, and has a convex shape on a lens surface 32 on the image side Lb.

The fourth lens 40 is made of resin. The fourth lens 40 has a negative power. The fourth lens 40 has a convex shape on a lens surface 41 on the object side La, and has a concave shape on a lens surface 42 on the image side Lb. The fourth lens 40 has an aspherical shape on both surfaces thereof.

The fifth lens 50 is made of resin. The fifth lens 50 has a positive power. The fifth lens 50 has a convex shape on a lens surface 51 on the object side La, and has a convex shape on a lens surface 52 on the image side Lb. The fifth lens 50 has an aspherical shape on both surfaces thereof.

The sixth lens 60 is made of resin. The sixth lens 60 has a positive power. The sixth lens 60 has a convex shape on a lens surface 61 on the object side La, and has a concave shape on a lens surface 62 on the image side Lb. The sixth lens 60 has an aspherical shape on both surfaces thereof.

### Lens Configuration

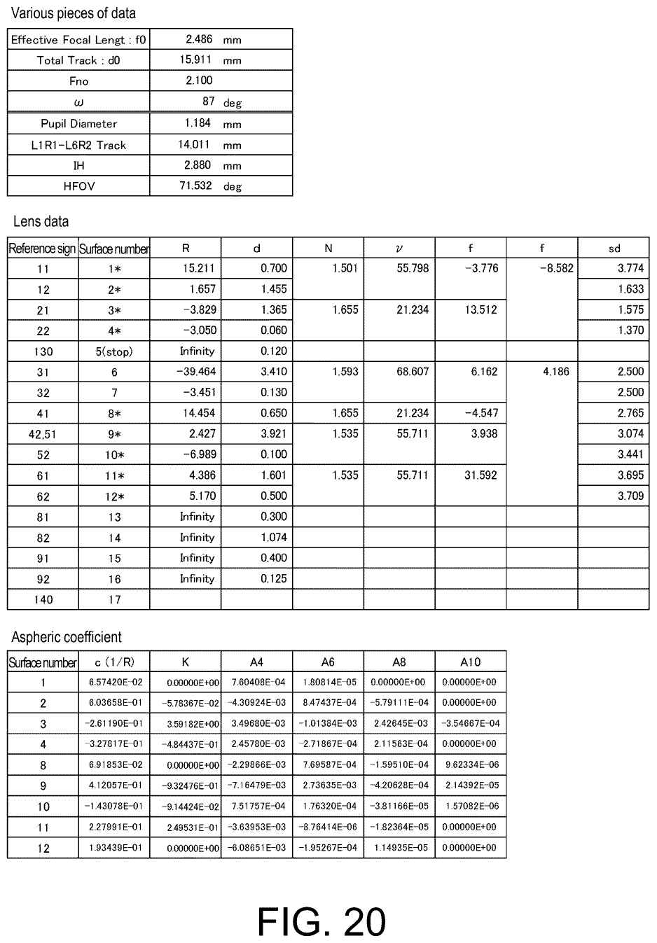

FIG. 20 is a diagram illustrating data of the imaging optical system 100 in the fourth embodiment. The imaging optical system 100 of the present embodiment satisfies the conditional expressions (1) to (9) described in the first embodiment.

In the present embodiment,

$$H F O V = 143.065$$

$$df = 3 \text{.520}$$

$$dr = 9.811$$

Therefore, HFOV=143.065, and the imaging optical system 100 satisfies the conditional expressions (1) and (1A). df/dr=0.359, and the imaging optical system 100 satisfies the conditional expressions (2) and (8).

In the present embodiment,

$$T 3 = 3.41$$

$$f 0 = 2.486$$

Therefore, T3/f0=1.372, and the imaging optical system 100 satisfies the conditional expression (3).

In the present embodiment,

$$R 31 = - 39 \text{.464}$$

$$R 32 = - 3.451$$

Therefore, (R31+R32)/(R31−R32)=1.192, and the imaging optical system 100 satisfies the conditional expression (4).

In the present embodiment,

$$f 3 = 6 \text{.162}$$

$$f 0 = 2.486$$

Therefore, f3/f0=2.478, and the imaging optical system 100 satisfies the conditional expression (5).

In the present embodiment,

$$d 0 = 15 \text{.911}$$

$$sd 11 = 3.774$$

Therefore, d0/sd11=4.216, and the imaging optical system 100 satisfies the conditional expression (6).

In the present embodiment,

$$d 0 = 15 \text{.911}$$

$$f 0 = 2.486$$

Therefore, d0/f0=6.400, and the imaging optical system 100 satisfies the conditional expression (7).

In the present embodiment,

$$d 0 = 15 \text{.911}$$

$$I H = 2.880$$

Therefore, d0/IH=5.525, and the imaging optical system 100 satisfies the conditional expression (9).

### Advantageous Effects

Since the imaging optical system 100 of the fourth embodiment satisfies the conditional expressions (1) to (9) similarly to the first embodiment, the imaging optical system 100 can provide advantageous effects similar to those of the first embodiment.

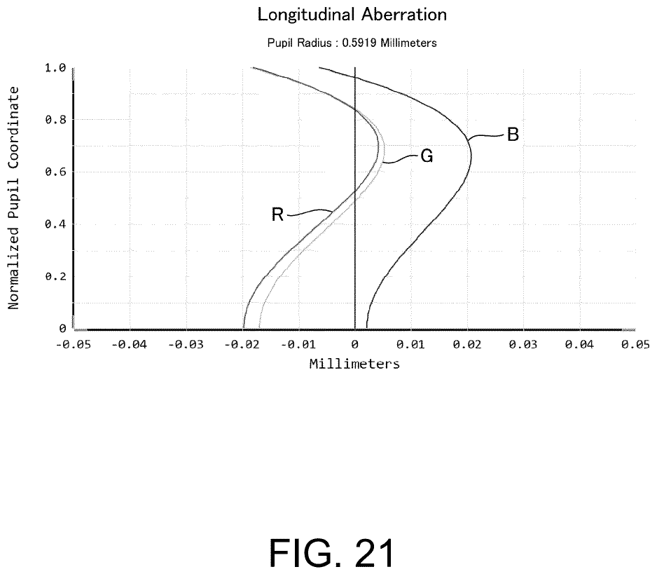

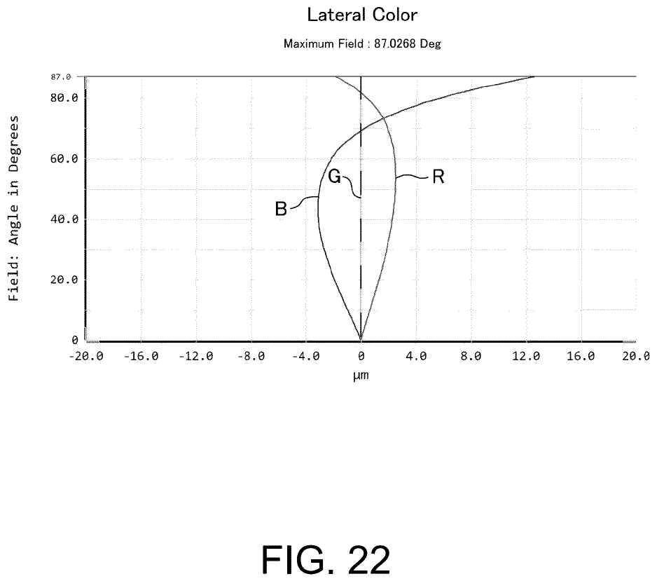

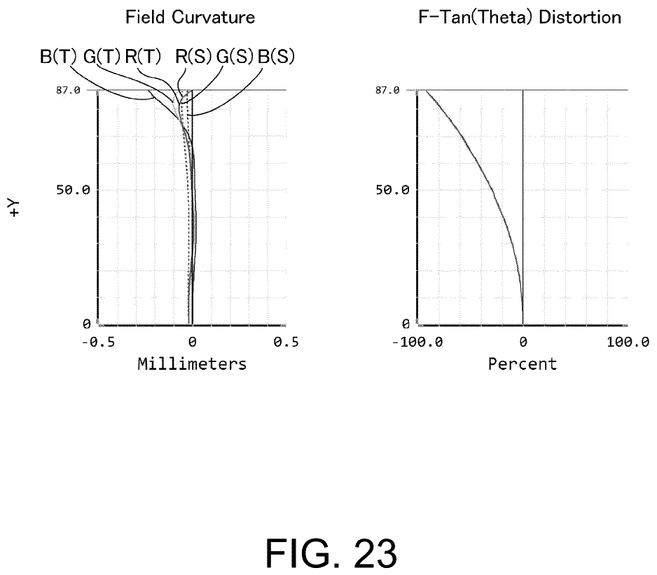

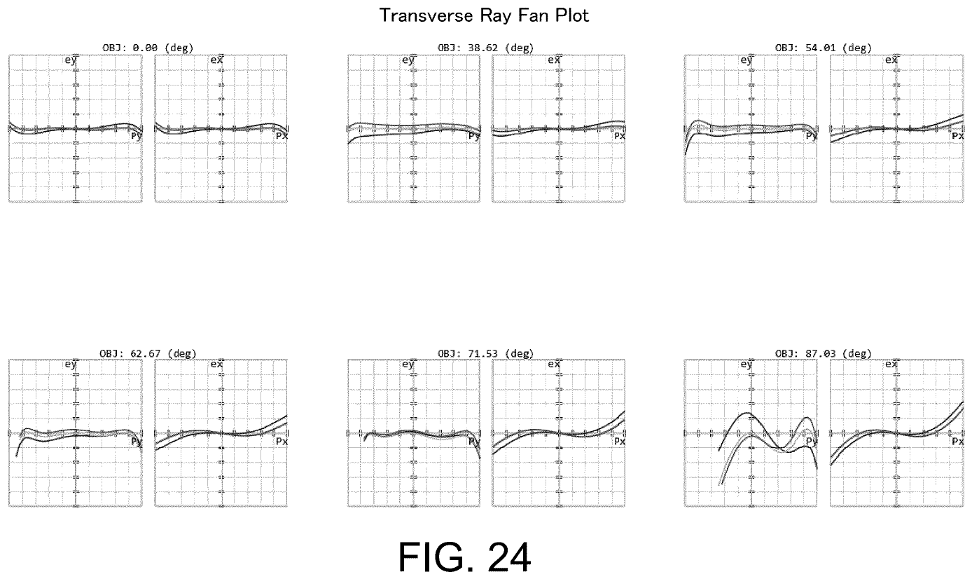

FIG. 21 is a diagram illustrating spherical aberrations of the imaging optical system 100 illustrated in FIG. 19. FIG. 22 is a diagram illustrating chromatic aberrations of magnification of the imaging optical system 100 illustrated in FIG. 19. FIG. 23 is a diagram illustrating astigmatisms and distortions of the imaging optical system 100 illustrated in FIG. 19. FIG. 24 is a diagram illustrating lateral aberrations of the imaging optical system 100 illustrated in FIG. 19.

As illustrated in FIGS. 21 to 24, in the imaging optical system 100 of the present embodiment, spherical aberrations, chromatic aberrations of magnification, astigmatisms (distortions), lateral aberrations, and resolutions are corrected to an appropriate level.

### Fifth Embodiment

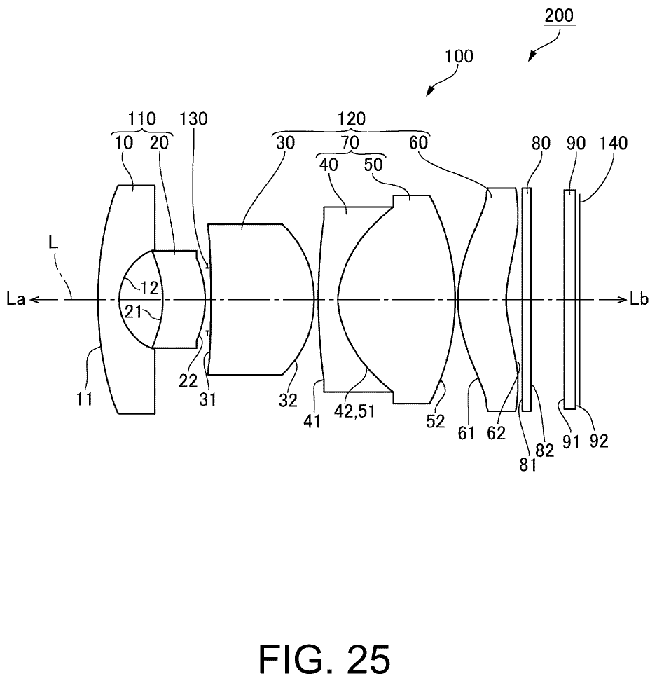

FIG. 25 is an explanatory diagram of an imaging device 200 according to a fifth embodiment. As illustrated in FIG. 25, the imaging device 200 of the present embodiment includes an imaging optical system 100, and an imaging element 140. The imaging optical system 100 includes, in order from an object side La toward an image side Lb, a front group 110, a diaphragm 130, a rear group 120, and an infrared cut filter 80.

The front group 110 is constituted of, in order from the object side La toward the image side Lb, a first lens 10 and a second lens 20. The rear group 120 is constituted of, in order from the object side La toward the image side Lb, a third lens 30, a fourth lens 40, a fifth lens 50, and a sixth lens 60. The fourth lens 40 and the fifth lens 50 are a cemented lens 70 bonded with an adhesive. On the image side Lb of the sixth lens 60, the flat infrared cut filter 80, a translucent cover 90, and the imaging element 140 are disposed in order from the object side La toward the image side Lb. The imaging element 140 is disposed on an imaging plane on the image side Lb of the imaging optical system 100.

The first lens 10 is made of resin. The first lens 10 has a negative power. The first lens 10 has a convex shape on a lens surface 11 on the object side La, and has a concave shape on a lens surface 12 on the image side Lb. The first lens 10 has an aspherical shape on the lens surface 12.

The second lens 20 is made of resin. The second lens 20 has a positive power. The second lens 20 has a concave shape on a lens surface 21 on the object side La, and has a convex shape on a lens surface 22 on the image side Lb. The second lens 20 has an aspherical shape on both surfaces thereof.

The third lens 30 is made of glass. The third lens 30 has a positive power. The third lens 30 has a concave shape on a lens surface 31 on the object side La, and has a convex shape on a lens surface 32 on the image side Lb.

The fourth lens 40 is made of resin. The fourth lens 40 has a negative power. The fourth lens 40 has a convex shape on a lens surface 41 on the object side La, and has a concave shape on a lens surface 42 on the image side Lb. The fourth lens 40 has an aspherical shape on both surfaces thereof.

The fifth lens 50 is made of resin. The fifth lens 50 has a positive power. The fifth lens 50 has a convex shape on a lens surface 51 on the object side La, and has a convex shape on a lens surface 52 on the image side Lb. The fifth lens 50 has an aspherical shape on both surfaces thereof.

The sixth lens 60 is made of resin. The sixth lens 60 has a positive power. The sixth lens 60 has a convex shape on a lens surface 61 on the object side La, and has a concave shape on a lens surface 62 on the image side Lb. The sixth lens 60 has an aspherical shape on both surfaces thereof.

### Lens Configuration

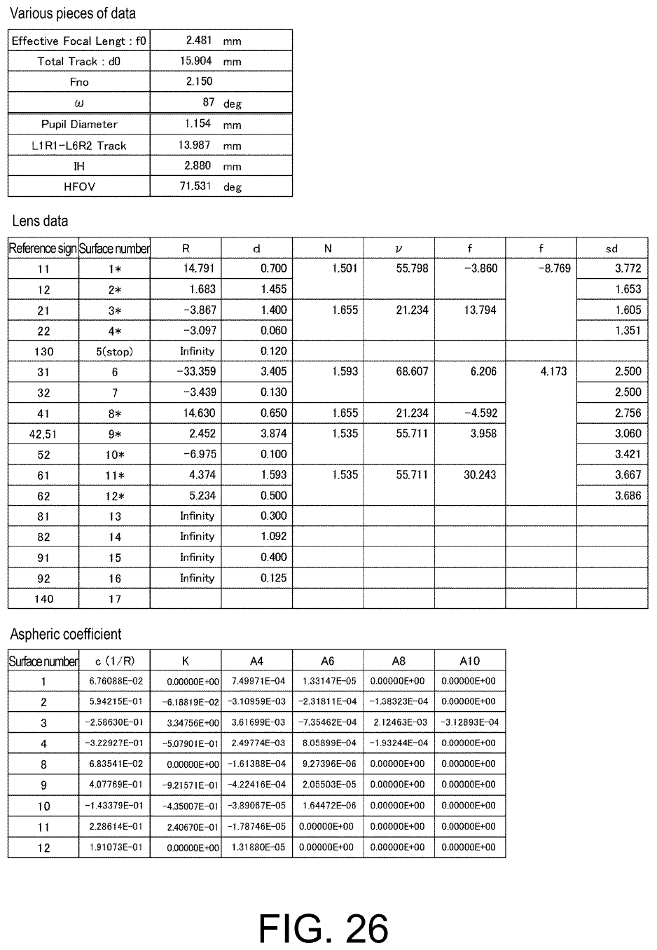

FIG. 26 is a diagram illustrating data of the imaging optical system 100 in the fifth embodiment. The imaging optical system 100 of the present embodiment satisfies the conditional expressions (1) to (9) described in the first embodiment.

In the present embodiment,

$$HFOV = 143.061$$

$$df = 3.555$$

$$dr = 9.752$$

Therefore, HFOV=143.065, and the imaging optical system 100 satisfies the conditional expressions (1) and (1A). df/dr=0.365, and the imaging optical system 100 satisfies the conditional expressions (2) and (8).

In the present embodiment,

$$T 3 = 3.405$$

$$f 0 = 2.481$$

Therefore, T3/f0=1.372, and the imaging optical system 100 satisfies the conditional expression (3).

In the present embodiment,

$$R 31 = - 33.359$$

$$R 32 = - 3.439$$

Therefore, (R31+R32)/(R31−R32)=1.230, and the imaging optical system 100 satisfies the conditional expression (4).

In the present embodiment,

$$f 3 = 6.206$$

$$f 0 = 2.481$$

Therefore, f3/f0=2.502, and the imaging optical system 100 satisfies the conditional expression (5).

In the present embodiment,

$$d 0 = 15.904$$

$$sd 11 = 3.772$$

Therefore, d0/sd11=4.216, and the imaging optical system 100 satisfies the conditional expression (6).

In the present embodiment,

$$d 0 = 15.904$$

$$f 0 = 2.481$$

Therefore, d0/f0=6.411, and the imaging optical system 100 satisfies the conditional expression (7).

In the present embodiment,

$$d 0 = 15.904$$

$$IH = 2.88$$

Therefore, d0/IH=5.522, and the imaging optical system 100 satisfies the conditional expression (9).

### Advantageous Effects

Since the imaging optical system 100 of the fifth embodiment satisfies the conditional expressions (1) to (9) similarly to the first embodiment, the imaging optical system 100 can provide advantageous effects similar to those of the first embodiment.

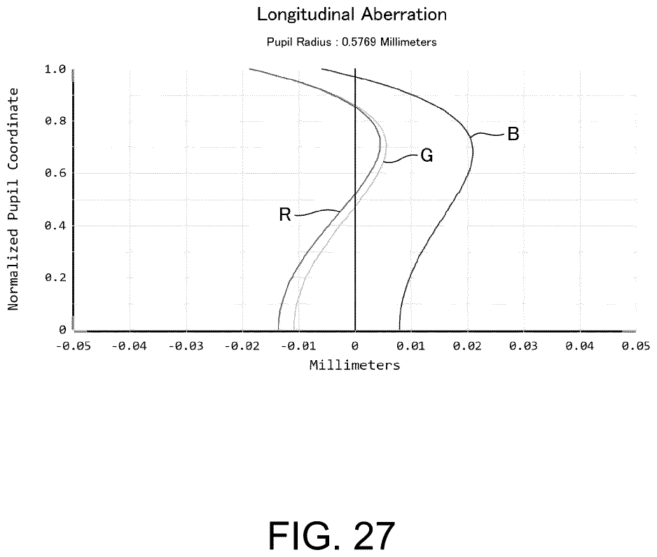

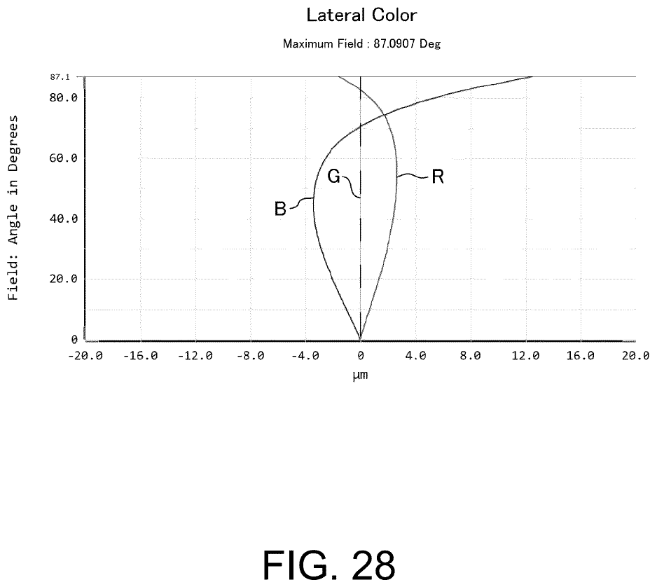

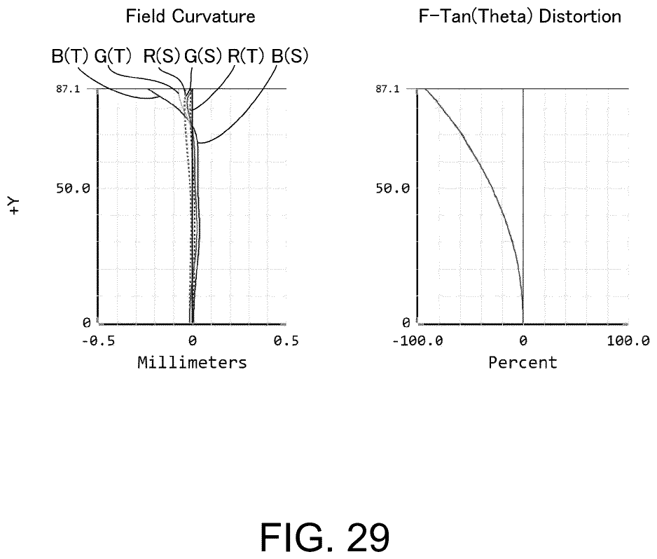

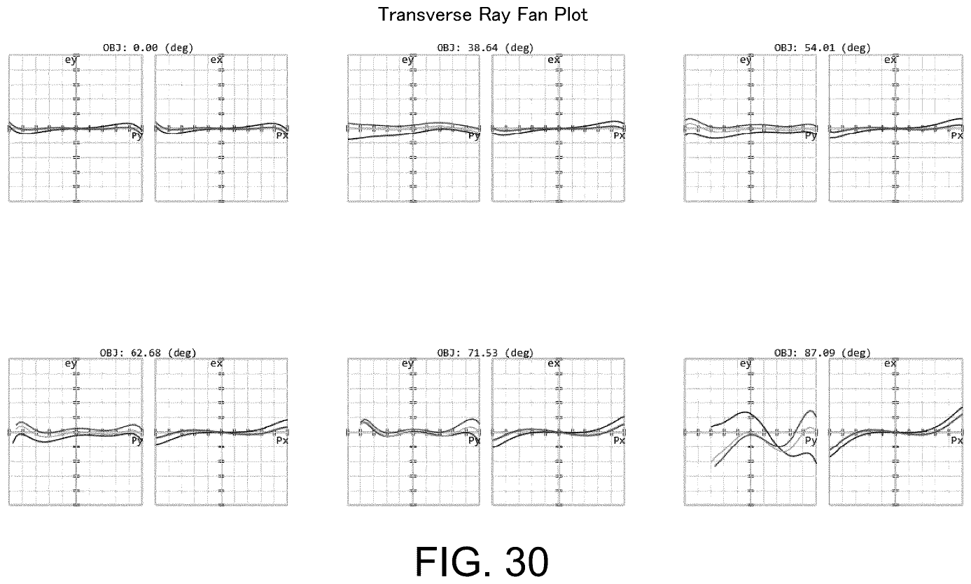

FIG. 27 is a diagram illustrating spherical aberrations of the imaging optical system 100 illustrated in FIG. 25. FIG. 28 is a diagram illustrating chromatic aberrations of magnification of the imaging optical system 100 illustrated in FIG. 25. FIG. 29 is a diagram illustrating astigmatisms and distortions of the imaging optical system 100 illustrated in FIG. 25. FIG. 30 is a diagram illustrating lateral aberrations of the imaging optical system 100 illustrated in FIG. 25.

As illustrated in FIGS. 27 to 30, in the imaging optical system 100 of the present embodiment, spherical aberrations, chromatic aberrations of magnification, astigmatisms (distortions), lateral aberrations, and resolutions are corrected to an appropriate level.

Note that, the present technique can be configured as follows.

### Supplementary Note 1

An imaging optical system including, in order from an object side toward an image side, a front group, a diaphragm, and a rear group, wherein
the front group is constituted of, in order from the object side toward the image side, a first lens and a second lens,
the rear group is constituted of, in order from the object side toward the image side, a third lens, a fourth lens, a fifth lens, and a sixth lens, and
when it is assumed that a viewing angle in a horizontal direction is HFOV, the entire length between the lenses of the front group is df, and the entire length between the lenses of the rear group is dr, the imaging optical system satisfies the following conditional expressions:

$$100 < HFOV \qquad ( 1 )$$

$$df / dr < 0.58 \qquad ( 2 )$$

### Supplementary Note 2

The imaging optical system according to supplementary note 1, wherein
when it is assumed that a thickness of the third lens is T3, and a focal length of an entire lens system is f0, the imaging optical system satisfies the following conditional expression:

$$1. < T 3 / f 0 < 2. \qquad ( 3 )$$

### Supplementary Note 3

The imaging optical system according to supplementary note 1 or 2, wherein the third lens has a positive power, includes a concave shape on a lens surface on the object side, and includes a convex shape on a lens surface on the image side.

### Supplementary Note 4

The imaging optical system according to supplementary note 3, wherein
the third lens is made of glass, and
when it is assumed that a radius of curvature of a lens surface on the object side of the third lens is R31, and a radius of curvature of a lens surface on the image side of the third lens is R32, the imaging optical system satisfies the following conditional expression:

$$1. < ( R 31 + R 32 ) / ( R 31 - R 32 ) < 1.5 \qquad ( 4 )$$

### Supplementary Note 5

The imaging optical system according to any one of supplementary notes 1 to 4, wherein
when it is assumed that a focal length of an entire lens system is f0, and a focal length of the third lens is f3, the imaging optical system satisfies the following conditional expression:

$$1.8 < f 3 / f 0 < 4. \qquad ( 5 )$$

### Supplementary Note 6

The imaging optical system according to any one of supplementary notes 1 to 5, wherein
when it is assumed that the entire length of an entire lens system is d0, an effective radius of a lens surface on the object side of the first lens is sd11, and a maximum image height is IH, the imaging optical system satisfies the following conditional expression:

$$3. < d 0 / sd 11 < 5.5 \qquad ( 6 )$$

### Supplementary Note 7

The imaging optical system according to any one of supplementary notes 1 to 6, wherein
when it is assumed that a focal length of an entire lens system is f0, and the entire length of the entire lens system is d0, the imaging optical system satisfies the following conditional expression:

$$5.5 < d 0 / f 0 < 9. \qquad ( 7 )$$

### Supplementary Note 8

The imaging optical system according to supplementary notes 1 to 7, wherein
when it is assumed that the entire length between the lenses of the front group is df, and the entire length between the lenses of the rear group is dr, the imaging optical system satisfies the following conditional expression:

$$0.2 < df / dr < 0.58 \qquad ( 8 )$$

### Supplementary Note 9

The imaging optical system according to any one of supplementary notes 1 to 8, wherein
when it is assumed that the entire length of an entire lens system is d0, and a maximum image height is IH, the imaging optical system satisfies the following conditional expression:

$$2. < d 0 / IH < 4. \qquad ( 9 )$$

### Supplementary Note 10

An imaging device including:
the imaging optical system according to any one of supplementary notes 1 to 9; and
an imaging element disposed on the image side of the imaging optical system.

What is claimed is:

1. An imaging optical system comprising, in order from an object side toward an image side, a front group, a diaphragm, and a rear group, wherein
the front group comprises, in order from the object side toward the image side, a first lens and a second lens,
the rear group comprises, in order from the object side toward the image side, a third lens, a fourth lens, a fifth lens, and a sixth lens, and
when it is assumed that a viewing angle in a horizontal direction is HFOV, an entire length between the lenses of the front group is df, and an entire length between the lenses of the rear group is dr, the imaging optical system satisfies the following conditional expressions:
$$100 < H F O V \qquad ( 1 )$$
$$df / dr < 0.58 . \qquad ( 2 )$$

2. The imaging optical system according to claim 1, wherein
when it is assumed that a thickness of the third lens is T3, and a focal length of an entire lens system is f0, the imaging optical system satisfies the following conditional expression:
$$1. < T 3 / f 0 < 2.0 0. \qquad ( 3 )$$

3. The imaging optical system according to claim 1, wherein
the third lens has a positive power, comprises a concave shape on a lens surface on the object side, and comprises a convex shape on a lens surface on the image side.

4. The imaging optical system according to claim 3, wherein
the third lens is made of glass, and
when it is assumed that a radius of curvature of a lens surface on the object side of the third lens is R31, and a radius of curvature of a lens surface on the image side of the third lens is R32, the imaging optical system satisfies the following conditional expression:
$$1. < ( R 31 + R 32 ) / ( R 31 - R 32 ) < 1.5 0. \qquad ( 4 )$$

5. The imaging optical system according to claim 1, wherein
when it is assumed that a focal length of an entire lens system is f0, and a focal length of the third lens is f3, the imaging optical system satisfies the following conditional expression:
$$1.8 < f 3 / f 0 < 4.0 0. \qquad ( 5 )$$

6. The imaging optical system according to claim 1, wherein
when it is assumed that an entire length of an entire lens system is d0, an effective radius of a lens surface on the object side of the first lens is sd11, and a maximum image height is IH, the imaging optical system satisfies the following conditional expression:
$$3. < d 0 / sd 11 < 5.5 . \qquad ( 6 )$$

7. The imaging optical system according to claim 1, wherein
when it is assumed that a focal length of an entire lens system is f0, and an entire length of the entire lens system is d0, the imaging optical system satisfies the following conditional expression:
$$5.5 < d 0 / f 0 < 9.0 0. \qquad ( 7 )$$

8. The imaging optical system according to claim 1, wherein
when it is assumed that an entire length between the lenses of the front group is df, and an entire length between the lenses of the rear group is dr, the imaging optical system satisfies the following conditional expression:
$$0.2 < df / dr < 0.5 80. \qquad ( 8 )$$

9. The imaging optical system according to claim 1, wherein
when it is assumed that an entire length of an entire lens system is d0, and a maximum image height is IH, the imaging optical system satisfies the following conditional expression:
$$2. < d 0 / I H < 4.0 0. \qquad ( 9 )$$

10. The imaging optical system according to claim 2, wherein
the third lens has a positive power, comprises a concave shape on a lens surface on the object side, and comprises a convex shape on a lens surface on the image side.

11. The imaging optical system according to claim 10, wherein
the third lens is made of glass, and
when it is assumed that a radius of curvature of a lens surface on the object side of the third lens is R31, and a radius of curvature of a lens surface on the image side of the third lens is R32, the imaging optical system satisfies the following conditional expression:
$$1. < ( R 31 + R 32 ) / ( R 31 - R 32 ) < 1.5 0. \qquad ( 4 )$$

12. The imaging optical system according to claim 11, wherein
when it is assumed that a focal length of the entire lens system is f0, and a focal length of the third lens is f3, the imaging optical system satisfies the following conditional expression:
$$1.8 < f 3 / f 0 < 4.0 0. \qquad ( 5 )$$

13. The imaging optical system according to claim 12, wherein
when it is assumed that an entire length of the entire lens system is d0, an effective radius of a lens surface on the object side of the first lens is sd11, and a maximum image height is IH, the imaging optical system satisfies the following conditional expression:
$$3. < d 0 / sd 11 < 5.5 . \qquad ( 6 )$$

14. The imaging optical system according to claim 13, wherein
when it is assumed that a focal length of the entire lens system is f0, and the entire length of the entire lens system is d0, the imaging optical system satisfies the following conditional expression:
$$5.5 < d 0 / f 0 < 9. . \qquad ( 7 )$$

15. The imaging optical system according to claim 14, wherein
when it is assumed that the entire length between the lenses of the front group is df, and the entire length between the lenses of the rear group is dr, the imaging optical system satisfies the following conditional expression:
$$0.2 < df / dr < 0.5 80. \qquad ( 8 )$$

16. The imaging optical system according to claim 15, wherein
when it is assumed that the entire length of the entire lens system is d0, and the maximum image height is IH, the imaging optical system satisfies the following conditional expression:
$$2. < d 0 / I H < 4.0 0. \qquad ( 9 )$$

17. The imaging optical system according to claim 2, wherein
when it is assumed that an entire length of the entire lens system is d0, and a maximum image height is IH, the imaging optical system satisfies the following conditional expression:
$$2. < d 0 / I H < 4.0 0. \qquad ( 9 )$$

18. An imaging device comprising:
the imaging optical system according to claim 1; and
an imaging element disposed on the image side of the imaging optical system.
